(19) United States
(12) Patent Application Publication
(10) Pub. No.: US 2010/0107904 A1
(43) Pub. Date: May 6, 2010

(54) SYSTEM AND METHOD FOR FLUID FLOW CONTROL

(75) Inventor: RICHARD KINGSWOOD KELLY, Toorak Gardens (AU)

Correspondence Address: WEINER & BURT, P.C., 635 N US-23, POB 186, HARRISVILLE, MI, 48740, US

(73) Assignee: SIPCO PTY LTD, Adelaide (AU)

(21) Appl. No.: 12/336,964

(22) Filed: Dec. 17, 2008

(30) Foreign Application Priority Data
Dec. 17, 2007 (AU) 2007906883

(51) Int. Cl. A01F 15/08; F04B 49/00; F04B 11/00; F04B 49/06; F16L 55/04; G05D 7/06; B30B 15/00

(52) U.S. Cl. 100/74; 417/20; 417/540; 417/44.1; 138/26; 137/8

(57) ABSTRACT

The present invention relates to a system and method for fluid flow control, for particular user in a hay baler. The system involves calculating or inputting a preferred flow rate (the Set Point), measuring the “actual” flow rate of liquid through the system, and controlling the speed of a pump used to move the liquid through the system to ensure that the flow rate is maintained as close as possible to the Set Point flow rate at all times during operation. The flow rate Set Point can be calculated using one or more user or sensor inputs, including the dose rate, the mass flow rate of fodder, the moisture content, etc.

The present invention relates to a system and method for fluid flow control and, in particular, to a system for accurately controlling the flow rate of liquid from a pump, by firstly smoothing out pressure pulses, measuring the flow rate, and adjusting power to the pump accordingly. The invention is intended for particular use in controlling the flow rate of preservative in a hay baler.

### BACKGROUND OF THE INVENTION

Many agricultural implements require the use of a pump to supply liquids such as inoculants and preservatives directly to agricultural products using spray nozzles and the like. These pumps are also used to supply a dose of chemicals, such as herbicides and pesticides, to be mixed with water and then sprayed onto agricultural products or onto the ground and plants. For example, a hay baler has a hay pick to which preservative is applied. The flow rate of these inoculants, preservatives, herbicides, pesticides and other farm chemicals is often required to be very low, often less than 1 Litre per minute.

in existing apparatus known to the present Applicant, such pumps are typically run at full speed and the flow rate control is achieved by selecting a particular size nozzle with a known flow rate at a given pressure, and adjusting the pressure from the pump to achieve the required flow using in line valve adjustment. This is often used as a bleed back to the main holding tank. Typically, this scheme is manually set and has no automatic control of the pressure or flow.

Controlling fluid flow from pumps requires that the flow rate from the pump be measured. Measuring the flow rate of fluid from pumps commonly used in agricultural implements has presented a problem, being that most of the pumps used are diaphragm pumps which send pressure pulses along the hoses which typically cause inaccuracies in the flow measurement. Exacerbating this problem is the overpressure valves and/or switches built into the pumps which may often cut in and out causing additional problems in relation to pressure change.

It is therefore an object of the present invention to overcome at least some of the aforementioned problems or provide the public with a useful alternative.

It is a further object of the present invention to provide a system and method for controlling fluid flow including a means of damping pressure pulses produced by a pump.

### SUMMARY OF THE INVENTION

Therefore, according to a first aspect of the present invention although this need not be the broadest, nor indeed the only aspect of the invention there is provided a system for controlling the flow rate of liquid from a pump, said apparatus including:

a means of establishing a target flow rate of liquid through the system;
a means of measuring an actual flow rate of liquid through the system;
a means of controllably regulating power input to the pump based upon the difference between the actual flow rate and the target flow rate, to ensure that the actual flow rate is thereafter maintained as close as possible to the target flow rate.

Preferably said system further includes a means of suppressing pressure pulses upstream of the means of measuring the actual flow rate.

In preference said means of suppressing pressure pulses upstream of said means of measuring the actual liquid flow rate is in the form of a dampener through which said liquid passes, said dampener including an oscillating diaphragm for dampening high frequency impulses present in the liquid.

Preferably said target flow rate of liquid through the system is input by a user.

Alternatively, said target flow rate of liquid through the system is calculated based upon one or more system parameters.

Preferably said means of controllably regulating power input to the pump is a control device. Advantageously said control device is a Proportional-Integral-Derivative (PID) controller.

In a further form of the invention there is proposed a system for controlling a pump used to transport liquid from a liquid holding tank to a means of applying the liquid to material passing through a chamber, said system including:

a means of establishing a target flow rate of liquid from the liquid holding tank to the means of applying the liquid;
a means of measuring an actual flow rate of liquid from the liquid holding tank to the means of applying the liquid;
a means of controllably regulating power input to the pump based upon the difference between the actual flow rate and the target flow rate, to ensure that the actual flow rate is maintained as close as possible to the target flow rate.

Preferably said system further includes a means of suppressing pressure pulses upstream of the means of measuring the actual flow rate.

In preference said target flow rate of liquid from the liquid holding tank to the means of applying the liquid is input by a user.

In preference said target flow rate of liquid from the liquid holding tank to the means of applying the liquid is calculated based upon one or more system parameters.

Preferably said one or more system parameters includes a detected mass flow rate of material passing through said chamber.

Preferably said one or more system parameters includes a dose rate of liquid, being the amount of liquid applied per weight of material.

In preference said one or more system parameters includes a detected moisture content in said material.

In preference said one or more detected parameters may alternatively be input by a user.

Preferably said means of controllably regulating power input to the pump is in the form of a control device. Advantageously said control device is a Proportional-Integral-Derivative (PID) controller.

Preferably said means of applying the liquid to said material is in the form of a spray nozzle.

Preferably said means of suppressing pressure pulses upstream of said means of measuring the actual liquid flow rate is in the form of a dampener through which said liquid passes, said dampener including an oscillating diaphragm for dampening high frequency impulses present in the liquid.

In preference said system further includes an alarm which is activated when said actual fluid flow rate is above a predetermined maximum upper limit, or below a predetermined lower limit.

In preference said system further includes an alarm which is activated when an inappropriate liquid is used.

Preferably said system further includes a means of adjusting the mass flow rate of material passing through the chamber.

Preferably said system further includes a means of measuring the total volume of fluid passed through the system.

In preference said system can be remotely operated.

In preference said system is used on an agricultural hay baler to apply liquid preservative to hay bales moving through a hay bale chamber.

In preference power supply to the pump is controlled using a pulse width modulator.

Preferably said liquid holding tank includes a low volume alarm.

In a still further form of the invention there is proposed a system for controlling the flow of liquid preservative pumped from a liquid preservative holding tank of a hay baler to a spray nozzle using a pump, said spray nozzle used to spray the liquid preservative over hay bales moving through a chamber, said system including:

a first sensor for detecting an actual flow rate of liquid preservative moving from the liquid preservative holding tank to the spray nozzle;
a controller adapted to calculate a target flow rate based upon user input and/or detected system parameters, said controller further being adapted to regulate power input to said pump based upon any difference between the target flow rate and the actual flow rate, to ensure that the actual flow rate is maintained as close as possible to the target flow rate.

In a yet further form of the invention there is proposed a method of controlling the flow rate of liquid from a pump to at least one liquid spray nozzle, said method comprising the steps of:

detecting an actual flow rate of said liquid moving from the pump to the at least one spray nozzle;
calculating a target flow rate based upon user input and/or detected parameters; comparing the actual flow rate with the target flow rate and controllably adjusting power supplied to the pump until said target flow rate is achieved.

In preference said method further includes the step of dampening pressure pulses in liquid downstream of the pump.

### DESCRIPTION OF DRAWINGS

The above and other objects, features, and advantages of the present invention will be apparent from the following detailed description of a preferred embodiment in conjunction with the accompanying drawings. In the drawings:

FIG. 1 illustrates a closed loop fluid flow control system in accordance with the present invention, including a pressure pulse suppression device;

FIG. 2 illustrates a block diagram of the closed loop fluid flow control system of FIG. 1;

FIG. 3 illustrates an underside view of a bottom section of a pressure pulse suppression device which may be used in the system of FIG. 1;

FIG. 4 illustrates a cross-sectional view of the bottom section of FIG. 3 through line A-A;

FIG. 5 illustrates an underside view of a top section of a pressure pulse suppression device which may be used in the system of FIG. 1;

FIG. 6 illustrates a cross-sectional view of the top section of FIG. 5 through line A-A;

FIG. 7 illustrates an underside view of the diaphragm used in the pressure pulse suppression device of FIG. 1; and

FIG. 8 illustrates a side view of the diaphragm of FIG. 7.

### DESCRIPTION OF THE PREFERRED EMBODIMENT

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

The present invention relates to an electronic control system 10 for particular use on a hay baler (not shown) of the type having a liquid preservative tank (not shown), and a pump 12 for pumping preservative from the tank to a spray nozzle (not shown), which in turn is used to apply the preservative to fodder (not shown). However, the present invention is not intended to be limited to such use, and could equally well be used in any mobile machine which requires the flow rate of liquid to be controlled in accordance with various detected and/or user input parameters.

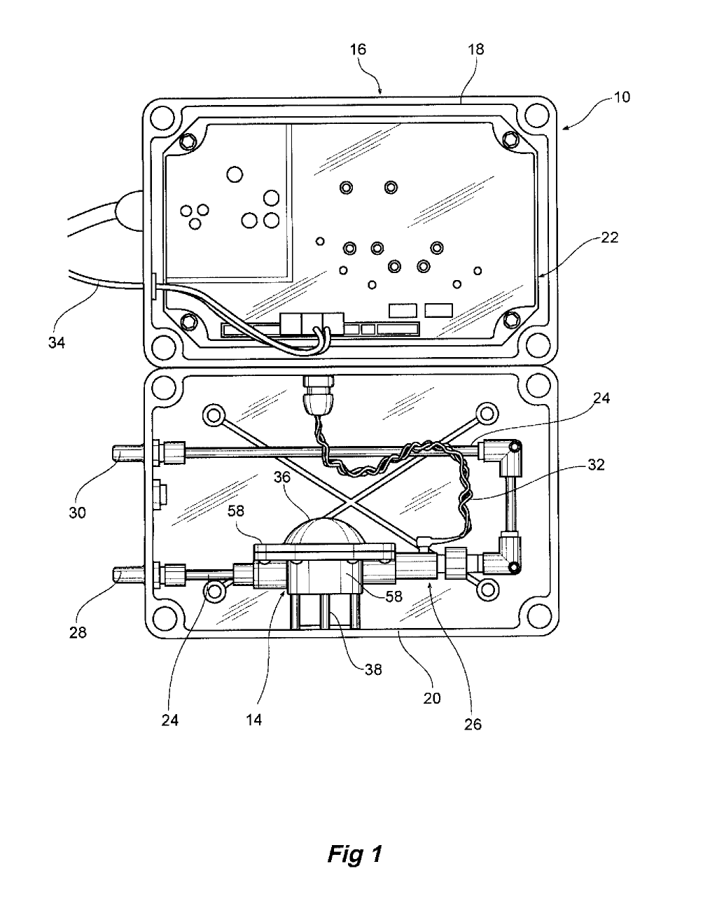

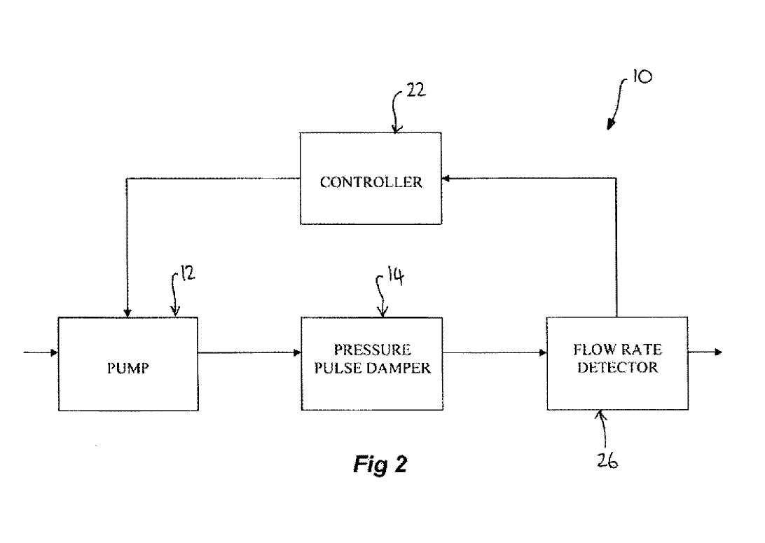

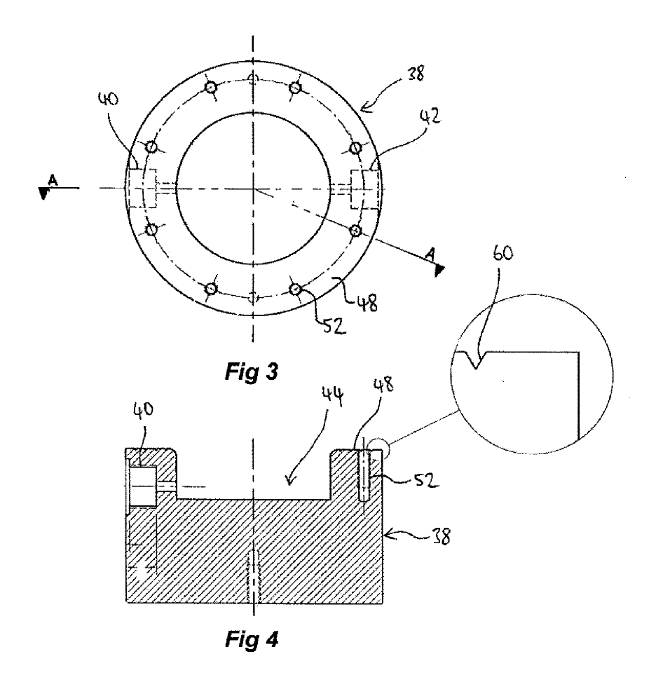

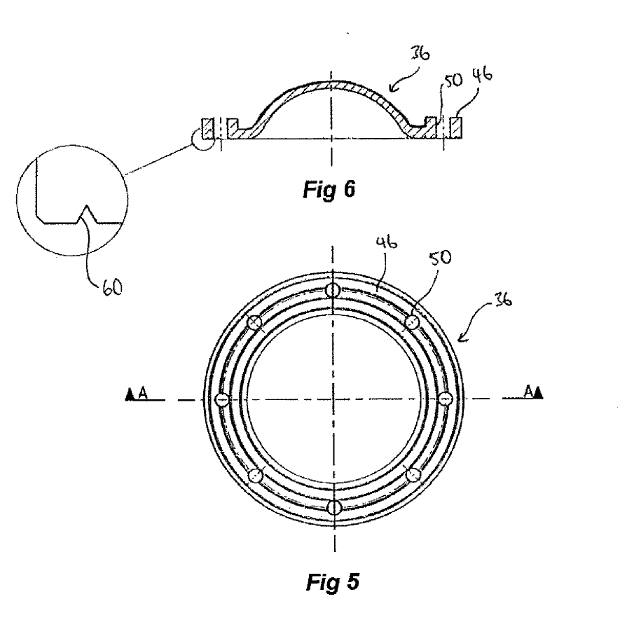

FIGS. 1-2 illustrate the control system 10 of the invention, and FIGS. 3-8 illustrate different views of a pressure pulse suppression device or dampener 14 used in the system 10.

Turning firstly to the system 10, the components are housed within a box-shaped housing 16 having upper and lower compartments 18 and 20 respectively. The upper compartment 18 houses an electronic control device or controller 22, while the lower compartment 20 houses a liquid flow line 24, the in-line dampener 14, and a flow rate sensor 26 positioned downstream of the dampener 14.

Preservative, or other liquid, is adapted to be pumped through an inlet port 28 in the side wall of the lower compartment 20 into the liquid flow line 24, through dampener 14, past the flow rate sensor 26, and out through an exit port 30 which is also positioned on the side wall of the lower compartment 20. The flow rate sensor 26 is electrically operated and communicates with the controller 22 through electrical wiring 32. The controller 22 is also connected to the pump 12 through wiring 34. The pump 12 however is not shown in FIG. 1.

In brief, one of the primary functions of the controller 22 is to control the speed of the pump 12 and hence the preservative flow rate, so that it is maintained as close as possible to a Set Point flow rate. The flow rate Set Point can be set manually by a user, or calculated by the controller 22 using inputs from various sensors.

For example, in a typical application, the operator will set the controller 22 to apply a given amount of preservative per tonne of fodder (the dose rate). The controller determines how many tonnes per hour (the mass flow rate) of fodder is being harvested through use of sensors:
at the baler fodder pickup (not shown) to indicate to the controller 22 when fodder is present, thereby signalling when to apply preservative (when fodder detected) and when not to (when no fodder detected); and
at a baler pre-compression chamber (not shown) to indicate to the controller 22 when a load of fodder in the pre-compression chamber is being sent into the bale chamber (not shown).

The controller 22 is adapted to continuously read in all the sensors, and combined with values that have been entered into the flow controller parameter list by an operator (for example, the dose rate), determines the optimum or Set Point flow rate of the preservative at any one point in time. There may be other data which has an effect on the Set Point flow rate, some of which may be detected by further sensors. For example, data relating to moisture levels in the fodder using a moisture gauge can be used, as well as general system status inputs from continuous internal flow controller checks.

It is to be understood that until the controller 22 believes it has a reliable mass flow rate and all other inputs indicate that all is well, the controller 22 operates the pump at the maximum flow rate that the operator has set to ensure enough preservative is being applied to preserve the fodder correctly. Once a reliable mass flow rate is detected, then the Set Point flow rate can be adjusted according to the various parameters.

The next step involves controlling the flow rate. Turning to FIG. 1 again, the controller 22 reads the actual flow rate from the flow rate sensor 26, and compares this reading with the calculated or input Set Point flow rate. If the flow rate does not match the Set Point flow rate, an error value is calculated and is used to change the speed of the pump in a controlled manner until the Set Point value is achieved. In the embodiment shown, the controller 22 is a Proportional-Integral-Derivative (PID) controller which uses an algorithm called a PID loop, which means it uses part of the error value based on a combination of a Proportional, Integrated and Differentiated mathematical treatment of the error value. However, any other suitable controller could be used.

To enable the control system to perform its task properly, a number of various other parameters need to be measured or set by the operator, including:
Tank volume when full (Litres);
Tank level at which warning should be sent to operator (Litres);
Time before system should be flushed with water (seconds)
Time before system should be primed with preservative (seconds)

It is to be understood that any number of parameters could be programmed into the controller 22, depending on the particular application. Such parameters can be easily input by an operator using a key pad, for example, which may be present in the cabin of the mobile machine and which is in electrical communication with the controller 22.

As mentioned, a dampener 14 is used upstream of the flow rate sensor 26. The function of the dampener 14 is to smooth out or damp the amplitude of pressure pulses, and particularly high frequency pressure pulses which are produced through use of the pump. This process is described in further detail below. The dampener 14 is positioned upstream of the flow rate sensor to ensure that an accurate measurement of the actual flow rate takes place.

The dampener 14 includes a top section 36 and a bottom section 38. The bottom section 38 is configured to be mounted to the base of the lower compartment 20 and includes inlet and exit ports 40 and 42 respectively to which the main flow line 24 is attached. The exact exterior shape of the bottom section is not important and the reader will appreciate that the exterior shape of the bottom section 38 shown in FIG. 1 differs slightly from that shown in FIG. 4.

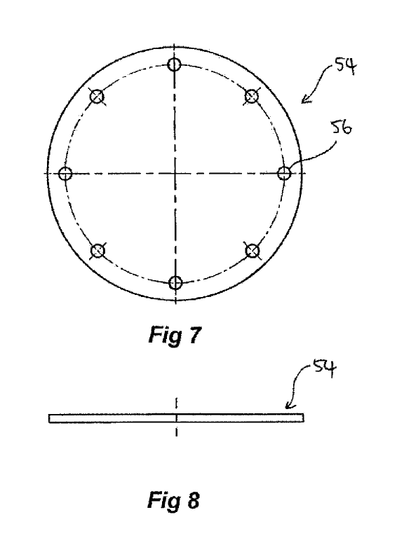

The internal shapes of the top and bottom sections are important. Between the inlet and exit ports of the bottom section 38 is a hollow substantially cylindrical sump area 44, whilst the top section 36 is substantially dome shaped. Each section 36 and 38 includes an outer annulus 46 and 48 respectively, having a plurality of radially disposed apertures 50 and 52. A circular diaphragm or membrane 54, shown separately in FIGS. 7-8, includes radially disposed apertures 56 which are positioned correspondingly with apertures 50 and 52 of the top and bottom sections.

The diaphragm 54 is adapted to be fixed between the top and bottom sections by coaxially aligning apertures 50, 52 and 56 and using an appropriate fixing means which extends through the apertures. In the embodiment shown, nuts and bolts 58 are used. The abutting surface of each annulus 46 and 48 include grooves 60 to ensure that the diaphragm is gripped tightly therebetween and forms a watertight seal. Those skilled in the art would realise that when liquid enters the sump area 44 it impinges against a large area of the diaphragm in a flow direction substantially perpendicular to the plane of the diaphragm. The diaphragm is constructed of a pliable material and therefore such force causes the diaphragm to oscillate within the internal area of the joined top and bottom sections, thereby dampening high frequency impulses present in the fluid.

The dampener 14 therefore acts as a fluid noise filter. The size and configuration of the dampener and diaphragm are selected to optimize the absorption of the fluid noise caused by the pump, which is typically a pulsating diaphragm pump, over the flow rate range required in the application.

In a preferred embodiment, the system 10 includes the following additional features:
An audible/visual alarm which is activated when the fluid flow rate is above a predetermined maximum upper limit, or below a predetermined lower limit;
An audible/visual alarm which is activated when an inappropriate liquid is used;
A means of adjusting the mass flow rate passing through the system. This is important when dosing for example, which requires that the fluid flow rate and the mass flow rate be kept proportional;
A means of allowing a user to input a desired mass flow rate;
A means of measuring the total volume of fluid passed through the system;
A means of remotely operating the system;
A pump power supply which is controlled by a pulse width modulator; and
An audible/visual alarm for indicating when the volume of liquid in the supply tank is at a predetermined low level.

The skilled addressee would now realise the benefits of the present invention. The system 10 involves calculating or inputting a preferred flow rate (the Set Point) at any one time, measuring the “actual” flow rate of liquid through the system, and controlling the speed of the pump to ensure that the flow rate is maintained as close as possible to the Set Point at all times during operation.

The invention has been described by way of example. The example is not, however, to be taken as limiting the scope of the invention in any way. Modifications and variations of the invention such as would be apparent to a skilled addressee are deemed to be within the scope of the invention.

In any claims that follow and in the summary of the invention, except where the context requires otherwise due to express language or necessary implication, the word “comprising” is used in the sense of “including”, i.e. the features specified may be associated with further features in various embodiments of the invention.

1. A system for controlling a flow of liquid from a liquid holding tank to a means of applying the liquid to material passing through a chamber, said system including:
a means of establishing a target flow rate of liquid from the liquid holding tank to the means of applying the liquid;
a means of measuring an actual flow rate of liquid from the liquid holding tank to the means of applying the liquid;
a means of controllably regulating the flow of liquid based upon the difference between the actual flow rate and the target flow rate, to ensure that the actual flow rate is maintained as close as possible to the target flow rate.

2. A system according to claim 1 including a pump for moving liquid from said liquid holding tank to said means of applying the liquid.

3. A system according to claim 2 wherein said means of controllably regulating the flow of liquid is a controller adapted to regulate power input to said pump.

4. A system according to claim 1 further including a means of suppressing pressure pulses upstream of the means of measuring the actual flow rate.

5. A system according to claim 1 wherein said target flow rate of liquid from the liquid holding tank to the means of applying the liquid is input by a user.

6. A system according to claim 1 wherein said target flow rate of liquid from the liquid holding tank to the means of applying the liquid is calculated based upon one or more system parameters.

7. A system according to claim 6 wherein said one or more system parameters includes a detected mass flow rate of material passing through said chamber.

8. A system according to claim 6 wherein said one or more system parameters includes a dose rate of liquid, being the amount of liquid applied per weight of material.

9. A system according to claim 6 wherein said one or more system parameters includes a detected moisture content in said material.

10. A system according to claim 6 wherein said one or more system parameters are input by a user.

11. A system according to claim 1 wherein said means of controllably regulating power input to the pump is in the form of a control device.

12. A system according to claim 11 wherein said control device is a Proportional-Integral-Derivative (PID) controller.

13. A system according to claim 1 wherein said means of applying the liquid to said material is in the form of a spray nozzle.

14. A system according to claim 2 wherein said means of suppressing pressure pulses upstream of said means of measuring the actual liquid flow rate is in the form of a dampener through which said liquid passes, said dampener including an oscillating diaphragm for dampening high frequency impulses present in the liquid.

15. A system for controlling the flow of liquid preservative pumped from a liquid preservative holding tank of a hay baler to a spray nozzle used to spray the liquid preservative over hay bales which move through a chamber, said system including:
a sensor for detecting an actual flow rate of liquid preservative moving from the liquid preservative holding tank to the spray nozzle;
a controller adapted to calculate a target flow rate based upon user input and/or detected system parameters, said controller further being adapted to regulate power input to said pump based upon any difference between the target flow rate and the actual flow rate, to ensure that the actual flow rate is maintained as close as possible to the target flow rate.

16. A system according to claim 15 further including a dampener positioned upstream of said sensor, said dampener including an oscillating diaphragm through which liquid passes, for dampening high frequency pulses present in the liquid.

17. A method of controlling a flow rate of liquid passing through a system, said method comprising the steps of:
detecting an actual flow rate of said liquid;
calculating a target flow rate based upon user input and/or detected system parameters;
comparing the actual flow rate with the target flow rate and controllably adjusting the flow rate until said target flow rate is achieved.

18. A method according to claim 17 wherein said system is a hay baler liquid preservative system, whereby liquid preservative is pumped from a liquid preservative holding tank to at least one spray nozzle used to apply the liquid preservative to hay bales moving through a chamber.

19. A method according to claim 18 wherein said user input and/or detected system parameters include dose rate of liquid, mass flow rate of hay bales moving through the chamber, and moisture content in said chamber.

20. A method according to claim 17 further including the step of dampening pressure pulses in liquid downstream of the pump.
